(19) United States
(12) Patent Application Publication
(10) Pub. No.: US 2014/0078157 A1
(43) Pub. Date: Mar. 20, 2014

(54) INFORMATION PROCESSING APPARATUS AND PARALLEL PROCESSING METHOD

(71) Applicant: Kabushiki Kaisha Toshiba, Tokyo (JP)

(72) Inventor: Takahiro SUZUKI, Hamura-shi (JP)

(73) Assignee: Kabushiki Kaisha Toshiba, Tokyo (JP)

(21) Appl. No.: 13/975,007

(22) Filed: Aug. 23, 2013

Related U.S. Application Data
(63) Continuation of application No. PCT/JP2013/057574, filed on Mar. 12, 2013.

(30) Foreign Application Priority Data
Sep. 20, 2012 (JP) 2012-207559

(51) Int. Cl. G06T 1/20

(52) U.S. Cl. CPC G06T 1/20
USPC 345/505

(57) ABSTRACT

According to one embodiment, an information processing apparatus includes a stage determination module, a score calculator and a pass window determination module. The stage determination module determines a process-target stage or process-target stages from plural stages, each of the plural stages rejecting a window of windows set on an image, wherein the rejected window does not include a target object. The score calculator calculates in parallel, scores of the windows in the process-target stages when the process-target stages have been determined. The pass determination module determines in parallel, pass or rejection of a window of the windows, based on two or more scores of the window in the process-target stages.

### CROSS REFERENCE TO RELATED APPLICATIONS

This application is a Continuation Application of PCT Application No. PCT/JP2013/057574, filed Mar. 12, 2013 and based upon and claiming the benefit of priority from Japanese Patent Application No. 2012-207559, filed Sep. 20, 2012, the entire contents of all of which are incorporated herein by reference.

### FIELD

Embodiments described herein relate generally to an information processing apparatus which executes a parallel processing, and a parallel processing method used in this apparatus.

### BACKGROUND

In recent years, a computer, in which a multi-core processor, or a GPU including a plurality of processors, is mounted, has been gaining in popularity. In such a computer, since a plurality of threads by a multithreaded program can be allocated to a plurality of processors (execution units), the computer executes the threads in parallel.

In addition, in a computer cluster or cloud computing, a program can similarly be processed in parallel by a plurality of computers which are mutually connected via a network.

In the meantime, in a program in which processes of a plurality of stages are sequentially (serially) executed, like a program including functions corresponding to a plurality of serially connected discriminators, a process of a certain stage is executed by using an output of a preceding stage. In such a process, a plurality of processes corresponding to a plurality of stages cannot be executed in parallel, and there is a possibility that plural processors cannot effectively be used.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a system configuration of an information processing apparatus according to an embodiment.

FIG. 2 is a view for explaining an example of a parallel processing executed by a plurality of execution units in the information processing apparatus of the embodiment.

FIG. 3 is a view for explaining an example of a process including a plurality of stages.

FIG. 4 is an exemplary graph illustrating the relationship between a stage and the number of threads in the process of FIG. 3.

FIG. 5 is a view for explaining an example of a process including a plurality of stages executed by the information processing apparatus of the embodiment.

FIG. 6 is an exemplary graph illustrating the relationship between a stage and the number of threads in the process of FIG. 5.

FIG. 7 is an exemplary block diagram illustrating a functional configuration of an image processing program executed by the information processing apparatus of the embodiment.

FIG. 8 is a view illustrating an example of dictionary data used by the information processing apparatus of the embodiment.

FIG. 9 illustrates examples of candidate windows set on input images having a pyramid structure, which are used by the information processing apparatus of the embodiment.

FIG. 10 illustrates examples of scaled candidate windows used by the information processing apparatus of the embodiment.

FIG. 11 is an exemplary view for describing a parallel processing of a plurality of stages executed by the information processing apparatus of the embodiment.

FIG. 12 is a view for explaining an example of extraction of candidate windows, based on the parallel processing of plural stages in FIG. 11.

FIG. 13 is a view for explaining another example of the extraction of candidate windows, based on the parallel processing of plural stages in FIG. 11.

FIG. 14 is a view for explaining another example of the process including a plurality of stages, which is executed by the information processing apparatus of the embodiment.

FIG. 15 is a flowchart illustrating an example of the procedure of an image process executed by the information processing apparatus of the embodiment.

### DETAILED DESCRIPTION

Various embodiments will be described hereinafter with reference to the accompanying drawings.

In general, according to one embodiment, an information processing apparatus includes execution units, a candidate window setting module, a stage determination module, a score calculator, and a pass window determination module. The candidate window setting module is configured to set candidate windows on an input image. The stage determination module is configured to determine one process-target stage or two or more process-target stages from a plurality of stages which are serially connected, each of the plurality of stages being configured to reject a candidate window from the candidate windows, wherein the rejected candidate window does not include a target object. The score calculator is configured to calculate in parallel, scores in each of the two or more process-target stages by the execution units when the two or more process-target stages have been determined, the scores corresponding to the candidate windows. The pass window determination module is configured to determine in parallel, pass or rejection of each of the candidate windows in the two or more process-target stages by the execution units, based on two or more scores in the two or more process-target stages, the two or more scores corresponding to a candidate window of the candidate windows.

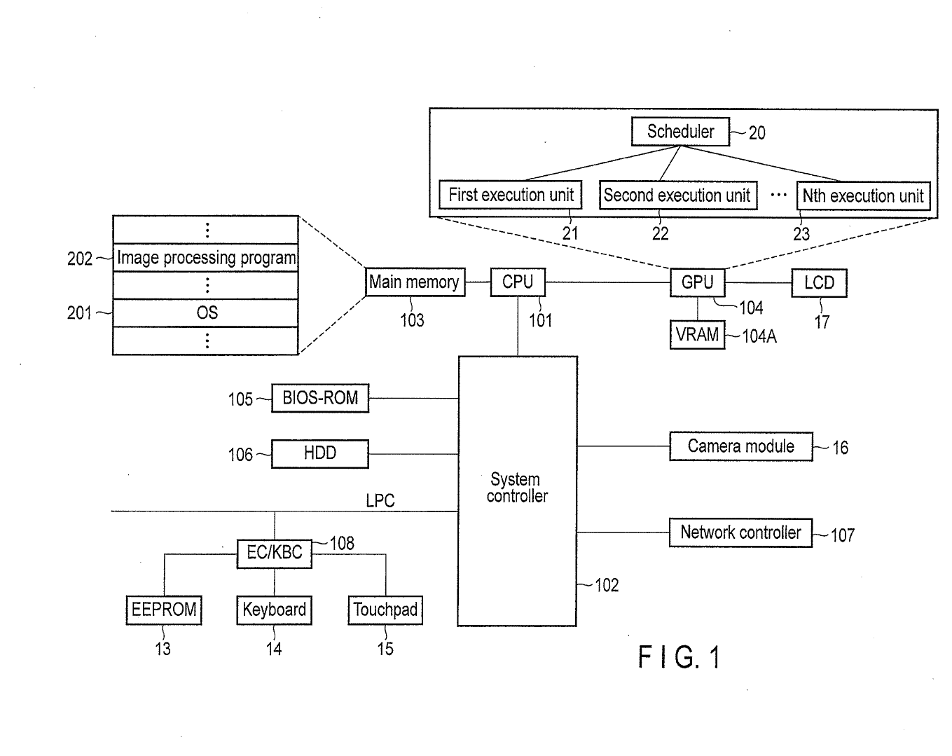

FIG. 1 illustrates a configuration of an information processing apparatus according to an embodiment. The information processing apparatus is realized, for example, as a personal computer, or an embedded system which is built in various kinds of electronic devices. This computer includes a CPU 101, a system controller 102, a main memory 103, a graphics processing unit (GPU) 104, a video memory (VRAM) 104A, a BIOS-ROM 105, an HDD 106, a network controller 107, an embedded controller/keyboard controller (EC/KBC) 108, an EEPROM 13, a keyboard 14, a touch pad 15, a camera module 16, and a display (LCD) 17. These components in the computer are interconnected via internal buses.

The CPU 101 is a processor for controlling the operations of the various modules in the computer. The CPU 101 executes various software programs which are loaded from the HDD 106, which is a storage device, into the main memory 103. These software programs include an operating system (OS) 201 and various application programs. The application programs include an image processing program 202. The image processing program 202 is a program for applying a predetermined image processing to input image data, and includes, for example, a function of detecting an area including a target object from an image. In addition, the CPU 101 includes a memory controller which access-controls the main memory 103.

Besides, the CPU 101 executes a basic input/output system (BIOS) stored in the BIOS-ROM 105. The BIOS is a program for hardware control.

The system controller 102 is a device which connects a local bus of the CPU 101 and various components. The system controller 102 includes a function of communicating with various components which are connected via, e.g. serial buses of PCI EXPRESS standards or USB standards.

The network controller 107 is a device which is configured to execute, for example, wired communication of Ethernet (trademark) standards or wireless communication of IEEE 802.11 standards.

The embedded controller/keyboard controller (EC/KBC) 108 is a one-chip microcomputer in which an embedded controller for power management and a keyboard controller for controlling the keyboard (KB) 13 and touch pad 15 are integrated. The EC/KBC 108 has a function of powering on/off the computer in accordance with the user's operation of a power button.

The GPU 104 is a display controller which controls the LCD 17 that is used as a display of the computer. A display signal, which is generated by the GPU 104, is sent to the LCD 17.

Aside from a graphics process such as generation of display signals, the GPU 104 can execute general arithmetic operations such as an image process and various simulation processes. The GPU 104 includes, for example, a scheduler 20 and a plurality of execution units (processor cores) 21, 22, 23. When a multithreaded program is executed, the scheduler 20 allocates a plurality of threads, into which a process corresponding to this program is divided, to the plural execution units 21, 22, 23. The thread is a process unit allocated to each of the execution units 21, 22, 23. The plural execution units 21, 22, 23 in the GPU 104 can operate the allocated threads in parallel. The above-described image processing program 202 is executed by the GPU 104 as a multithread process in which the plural threads, into which the process by the image processing program 202 is divided, operate in parallel.

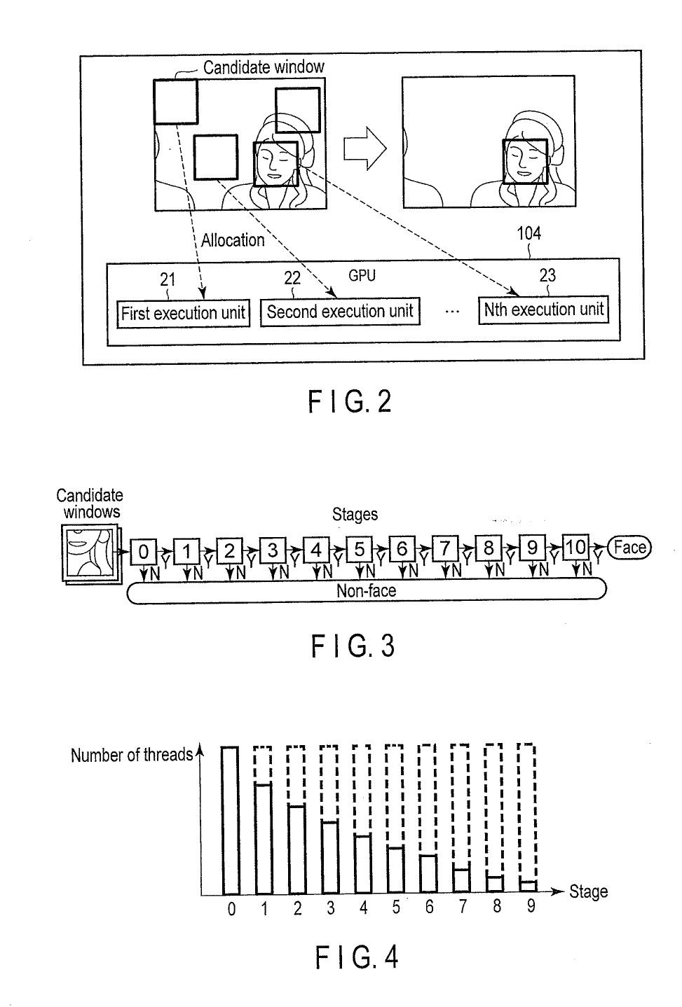

FIG. 2 illustrates an example in which the image processing program 202 is parallel-processed. In the example shown in FIG. 2, it is assumed that the image processing program 202 includes a function of detecting a window including a target object (e.g. a person's face) from a plurality of candidate windows which are set on an image. The process for determining whether a candidate window set on an image includes a target object or not, is an independent process for each of candidate windows. Thus, processes (threads) for a plurality of candidate windows are respectively allocated to the plural execution units 21, 22, 23, and are executed in parallel. Thereby, a window including a target object can be detected at a higher speed than in the case of serially executing processes for plural candidate windows.

In addition, FIG. 3 illustrates an example of a process (a multi-stage process) including a plurality of stages which are connected in series. In this process, a subsequent-stage process is executed by using a result of a precedent-stage process, like a plurality of discriminators which are connected in series. For example, in the above-described process of detecting a window including a target object from candidate windows, candidate windows which are assumed to include the target object are narrowed down (“screened”) on a stage-by-stage basis, and a candidate window, which has been left after the completion of processes in all stages, is acquired as the window including the target object.

As illustrated in FIG. 3, in each stage, it is determined whether to pass a candidate window (Y) or to reject (discard) the candidate window (N). For example, in a 0th stage, it is determined whether to pass each of candidate windows set on an input image, or to reject each of them. Then, in a first stage, it is determined whether to pass each of the candidate windows, which have passed the 0th stage, or to reject each of them. The candidate window, which has been rejected in each stage, is screened out as a window (“Non-face”) which does not include the target object, and the candidate window, which has passed all stages, is acquired as a window (“Face”) including the target object.

In each stage, a plurality of threads for a plurality of candidate windows are allocated to a plurality of execution units 21, 22, 23, and are executed in parallel. In this process, as illustrated in FIG. 4, since the candidate windows are gradually narrowed down on a stage-by-stage basis toward the last stage, the number of threads becomes gradually smaller toward the last stage. Thus, in the case where the number of threads in a certain stage is less than the number of execution units 21, 22, 23 in the GPU 104, it is possible that some of the execution units 21, 22, 23 transition into an idle state and are not effectively used.

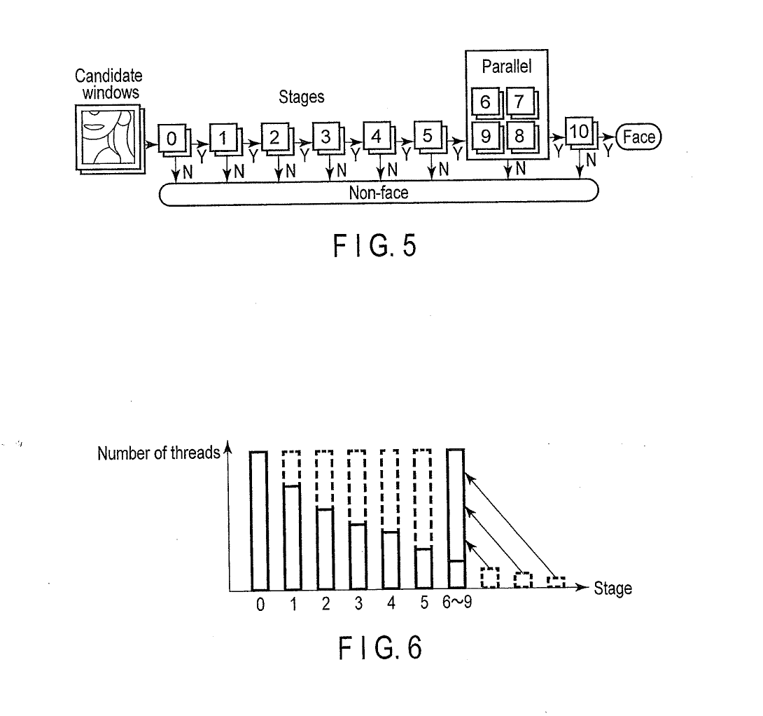

Taking this into account, in the present embodiment, a plurality of stages are processed in parallel in accordance with the number of candidate windows. In an example shown in FIG. 5, four stages, namely a sixth stage to a ninth stage, are processed in parallel. Since the processes of these four stages are executed simultaneously after the completion of the process of the fifth stage, each of inputs to the four stages is candidate windows which have passed the fifth stage. Consequently, in the seventh to ninth stages, it is possible that a process is executed for candidate windows which would have been normally rejected in the preceding stage, and a useless process may occur.

However, as illustrated in FIG. 6, for example, by putting together the four stages, i.e. the sixth stage to ninth stage, the number of threads, which can be operated at the same time, increases. Hence, the execution units 21, 22, 23 in the GPU 104 can be operated without a halt and can be effectively used (i.e. the number of execution units 21, 22, 23, which transition into an idle state, can be reduced). In addition, compared to the case where the sixth stage to ninth stage are serially (sequentially) processed, the time that is needed for the whole process can be decreased.

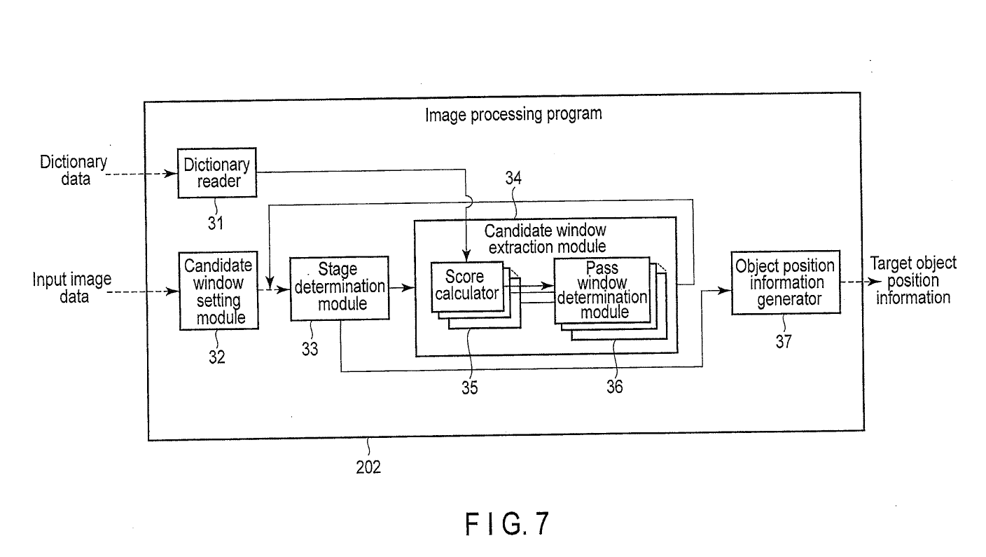

Referring now to FIG. 7, the configuration of the image processing program 202 is described. The image processing program 202 includes a function of detecting a window including a target object by screening a plurality of candidate windows set on an input image, in each of a plurality of stages. By being executed on the GPU 104, the image processing program 202, in cooperation with the scheduler 20 and plural execution units 21, 22, 23, executes a parallel processing of a plurality of threads corresponding to the above-described function.

The image processing program 202 includes, for example, a dictionary reader 31, a candidate window setting module 32, a stage determination module 33, a candidate window extraction module 34 and an object position information generator 37. In addition, the candidate window extraction module 34 includes score calculators 35 and pass window determination modules 36.

The dictionary reader 31 reads dictionary data used in each of plural stages from a storage medium (e.g. HDD 106). The dictionary data is indicative of features of a detection target object (e.g. a person's face). This dictionary data includes data in which the appearance of the detection target object is pre-learned. The dictionary data includes the features of the target object, which have been obtained, for example, by analyzing many images including the target object. As the features, for instance, Joint Haar-like features are used.

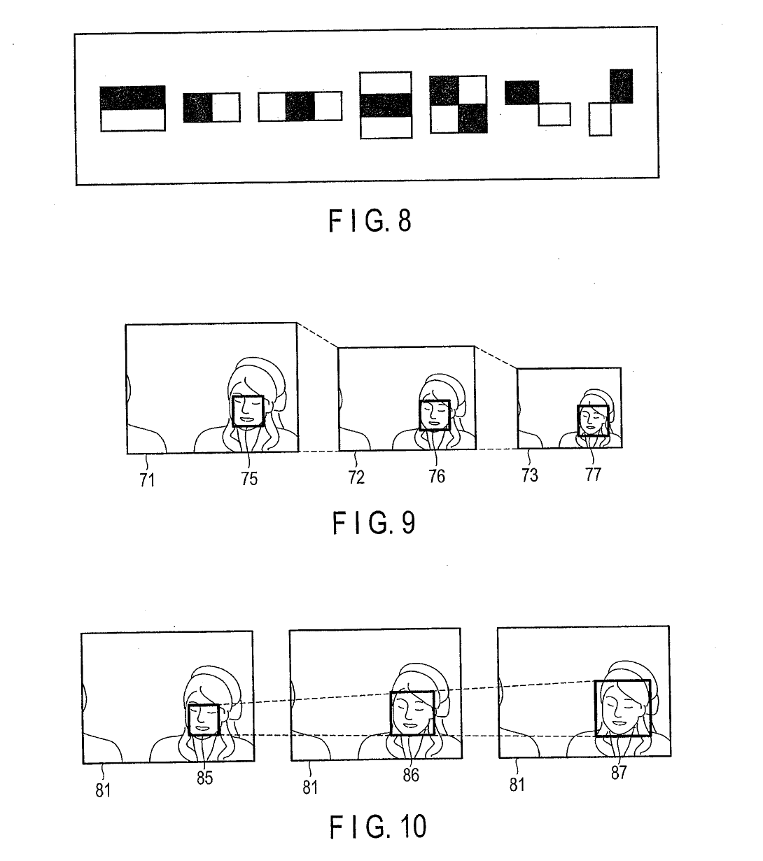

The Joint Haar-like feature is a feature based on cooccurrence of a plurality of Haar-like features. As shown in FIG. 8, the Haar-like feature is represented as a luminance difference between neighboring rectangular areas. Since luminance values per se are not used for the Haar-like feature amount, the influence of a variation of the illumination condition or noise can be reduced.

To be more specific, the Haar-like feature amount is a scalar amount which is obtained as a difference value of mean luminances of rectangular areas, and the value thereof is representative of an intensity of a luminance gradient. In the discrimination of candidate windows (samples) using the Haar-like feature, it is stipulated that a value is returned based on the Haar-like feature amount. For example, “1” is returned if a sample of a determination target is a candidate window that is to be detected (positive sample), and “0” is returned if the sample of the determination target is a candidate window that is not to be detected (negative sample).

The Joint Haar-like feature amount is a value obtained by putting together outputs based on a plurality of Haar-like feature amounts having a cooccurrence relation. For example, when values “1”, “1” and “0” have been returned by discrimination based on three Haar-like features for a certain determination-target candidate window, the Joint Haar-like feature amount is expressed by (110)₂₌₆. In the description below, the feature amount (e.g. Joint Haar-like feature amount) calculated for the determination-target candidate window is also referred to as “score”. In the discrimination using the Joint Haar-like feature in the embodiment, for example, in a process-target stage, if the Joint Haar-like feature amount (score) of a certain candidate window is equal to or greater than a threshold, it is determined that this candidate window is to pass the process-target stage. In addition, if the Joint Haar-like feature amount (score) is less than the threshold, it is determined that this candidate window is to be rejected.

A plurality of Haar-like features having a cooccurrence relation, which are used as a Joint Haar-like feature, vary from stage to stage. For example, in stages closer to the last stage, more complex Haar-like features are included (e.g. the number of combined rectangles is greater).

The dictionary reader 31 outputs read dictionary data to the candidate window extraction module 34 (score calculators 35).

The candidate window setting module 32 acquires input image data, and sets a plurality of candidate windows on an input image based on the input image data. This input image data is acquired, for example, via a memory medium (memory) or the camera module 16. The candidate window setting module 32 sets, for example, candidate windows of a predetermined size on the input image at predetermined intervals.

The size of an image of a target object on the input image may be unknown. Specifically, on the input image, the image of the target object may be included with various sizes. Thus, the candidate window is set so that the size of the image of the target object on the input image may not affect the detection of the target object.

FIGS. 9 and 10 illustrate examples of candidate windows set on the input image. In the example shown in FIG. 9, candidate windows 75, 76 and 77 of the same size are set on input images 71, 72 and 73 having a three-layered pyramid structure (i.e. input images scaled in three layers). In addition, in the example shown in FIG. 10, candidate windows 85, 86 and 87, which are scaled in three layers, are set on an input image 81. By this setting of candidate windows, it is possible to detect an area including a target object from an input image, regardless of the size of the target object on the input image.

The stage determination module 33 determines one process-target stage or two or more process-target stages, from a plurality of stages which are serially connected and each of which rejects (discards) candidate windows including no target object from a plurality of candidate windows. This one process-target stage or the two or more process-target stages may be determined based on a prescribed process order and combination of stages, or may be dynamically determined based on the number of candidate windows or the number of execution units (processor cores) 21, 22, 23 in the GPU 104.

The stage determination module 33 requests the candidate window extraction module 34 to process the candidate windows set on the input image by the determined one process-target stage or two or more process-target stages. To be more specific, in the first stage, the stage determination module 33 requests the candidate window extraction module 34 to process a plurality of candidate windows set by the candidate window setting module 32, by the determined one process-target stage or two or more process-target stages. In the stages other than the first stage, the stage determination module 33 requests the candidate window extraction module 34 to process a plurality of candidate windows which have passed the stage processed immediately before (i.e. the preceding stage), by the determined one process-target stage or two or more process-target stages.

In response to a request from the stage determination module 33, the candidate window extraction module 34 executes in parallel, a process of determining pass or rejection of candidate widows in one process-target stage, or a process of determining pass or rejection of candidate widows in two or more process-target stages, by the plural execution units 21, 22, 23. The candidate window extraction module 34 determines, by using dictionary data, whether a candidate window is close to the appearance of the target object, thereby determining pass or rejection of this candidate window. The candidate window extraction module 34 may include a plurality of score calculators (score calculation threads) 35 and a plurality of pass window determination modules (pass window determination threads) 36.

Next, to begin with, a description is given of a process of determining pass or rejection of candidate windows in one process-target stage.

When one process-target stage has been determined by the stage determination module 33, the score calculators 35 calculate in parallel, by the plural execution units 21, 22, 23, a plurality of scores (feature amounts) in one process-target stage, which correspond to candidate windows set on the input image (candidate windows which have passed the preceding stage). To be more specific, each of the plural score calculators (score calculation threads) 35 calculates the score of the target candidate window by using the pixel values of the pixels in the target candidate window and the dictionary data indicative of the features of the target object for the one process-target stage. The score of the target candidate window may be a cumulative value of the score in the one process-target stage and the scores calculated in the stages up to the preceding stage. The plural score calculation threads 35 are allocated to the plural execution units 21, 22, 23 and operate in parallel.

The pass window determination modules 36 determine in parallel, by the plural execution units, the pass or rejection of each of candidate windows, based on one score in one process-target stage, the one score corresponding to a candidate window of the candidate windows set on the input image. To be more specific, each of the pass window determination modules (pass window determination threads) 36 determines the pass or rejection of a target candidate window, based on the score of the target candidate window. The plural pass window determination threads 36 are allocated to the plural execution units 21, 22, 23, respectively, and operate in parallel. For example, a certain pass window determination thread 36 determines that a first candidate window of candidate windows is to pass one process-target stage if one score corresponding to this first candidate window is equal to or greater than a threshold, and determines that the first candidate window is to be rejected if the score is less than the threshold.

The pass window determination module (pass window determination thread) 36 outputs the candidate window passed the one process-target stage, to the stage determination module 33. In addition, the pass window determination module (pass window determination thread) 36 deletes the rejected candidate window from the candidate windows set on the input image. Specifically, the pass window determination modules 36 output candidate windows, which have been narrowed down by the present process-target stage, to the stage determination module 33 as candidate windows (passed windows) which are to be processed in the subsequent stage.

Next, a description is given of a process of determining pass or rejection of candidate windows in two or more process-target stages.

When two or more process-target stages have been determined by the stage determination module 33, the score calculators 35 calculate in parallel, by the plural execution units 21, 22, 23, a plurality of scores in each of the two or more process-target stages. The scores correspond to candidate windows set on the input image (i.e. candidate windows which have passed the preceding stage). To be more specific, each of the plural score calculators (score calculation threads) 35 calculates the score of the target candidate window in each process-target stage by using the pixel values of the pixels in the target candidate window and the dictionary data indicative of the features of the target object for each of the two or more process-target stages. The score of the target candidate window may be a cumulative value of the score in the process-target stage and the scores calculated in the stages up to the preceding stage. The plural score calculation threads 35 are allocated to the plural execution units 21, 22, 23 and operate in parallel. To be more specific, that number of score calculation threads 35, which corresponds to the product between the number of candidate windows and the number of process-target stages (for example, 320 threads when 80 candidate windows are processed in paralleled four stages) operate in parallel.

The pass window determination modules 36 determine in parallel, by the plural execution units, the pass or rejection of each of candidate windows, based on two or more scores in the two or more process-target stages, the two or more scores corresponding to a candidate window of the candidate windows. The pass window determination modules 36 reject all of candidate windows which are to be rejected in any one of the two or more process-target stages, based on the two or more scores in the two or more process-target stages.

To be more specific, each of the plural pass window determination modules (pass window determination threads) 36 determines the pass or rejection of a target candidate window, based on two or more scores in two or more process-target stages, the two or more scores corresponding to the target candidate window. For example, the pass Window determination thread 36 determines that a certain candidate window is to pass the two or more process-target stages if the sum of the two or more scores corresponding to this candidate window is equal to or greater than a threshold. In addition, the pass window determination thread 36 determines that the candidate window is to be rejected if the sum of the two or more scores is less than the threshold. The plural pass window determination threads 36 are allocated to the plural execution units 21, 22, 23 and operate in parallel. To be more specific, that number of pass window determination threads 36, which corresponds to the number of candidate windows (for example, 80 threads when the number of candidate windows is 80) operate in parallel.

The pass window determination module (pass window determination thread) 36 outputs the candidate window which has passed the two or more process-target stages to the stage determination module 33. In addition, the pass window determination module (pass window determination thread) 36 deletes the candidate window, which has been determined to be rejected, from the candidate windows set on the input image. Specifically, the pass window determination modules 36 output candidate windows, which have been narrowed down by the present two or more process-target stages, to the stage determination module 33 as candidate windows (passed windows) which are to be processed in the subsequent stage.

After the pass or rejection of plural candidate windows in one process-target stage was determined, or after the pass or rejection of plural candidate windows in two or more process-target stages was determined, the stage determination module 33 determines whether the process up to the last stage has been completed or not. When the process up to the last stage has not been completed, the stage determination module 33 determines a new process-target stage or new process-target stages (i.e. new one process-target stage or new two or more process-target stages) which follow the present one process-target stage or two or more process-target stages. Then, the stage determination module 33 requests the candidate window extraction module 34 to process candidate windows output from the pass window determination modules 36, that is, passed windows which were determined to pass the preceding stage, in the determined new process-target stage(s). In the process in the new process-target stage(s), the pass windows are subjected to the same process as described above.

Specifically, when new one process-target stage was determined, the score calculators 35 calculate in parallel, by the plural execution units 21, 22, 23, a plurality of scores in the new one process-target stage, the scores corresponding to candidate windows (passed windows) the pass of which was determined by the pass window determination module 36. Then, the pass window determination modules 36 determine in parallel, by the plural execution units, the pass or rejection of each of the passed windows in the new one process-target stage, based on one score in the new one process-target stage, which corresponds to a passed window of the passed windows.

In addition, when new two or more process-target stages were determined, the score calculators 35 calculate in parallel a plurality of scores in the new two or more process-target stages by the plural execution units 21, 22, 23. The scores correspond to the plural candidate windows (passed windows) the pass of which was determined by the pass window determination module 36. Then, the pass window determination modules 36 determine in parallel, the pass or rejection of each of the passed windows in the new two or more process-target stages by the plural execution units 21, 22, 23. The pass window determination module 36 determines the pass or rejection of a window of the passed windows in the new stages based on two or more scores in the two or more new process-target stages, the two or more scores corresponding to the window.

When the process up to the last stage has been completed, the stage determination module 33 requests the object position information generator 37 to generate position information of the target object. The candidate windows, which have passed the last stage, are indicative of areas including the target object. The object position information generator 37 generates and outputs the position information (a plurality of pieces of position information) of the target object, based on the area corresponding to the candidate window (candidate windows) which has passed the last stage. The object position information generator 37 generates, for example, information including the coordinates and size of each of candidate windows which have passed the last stage. For example, two candidate windows having a displacement of several pixels or less are assumed to be windows indicative of the same target object on the input image. Thus, the object position information generator 37 may generate position information by putting together such candidate windows into one.

By the above-described configuration, the area (candidate window) including the target object can be detected from the input image. In addition, when the plural execution units 21, 22, 23 execute the image process including serially connected plural stages for narrowing down candidate windows, the time of this process can be shortened.

The above-described parallel processing can be similarly executed in a multi-core CPU, a computer cluster, a cloud servers, etc., as well as in the GPU 104 including the plural execution units 21, 22, 23, and the same advantageous effects can be obtained as in the case of the execution on the GPU 104.

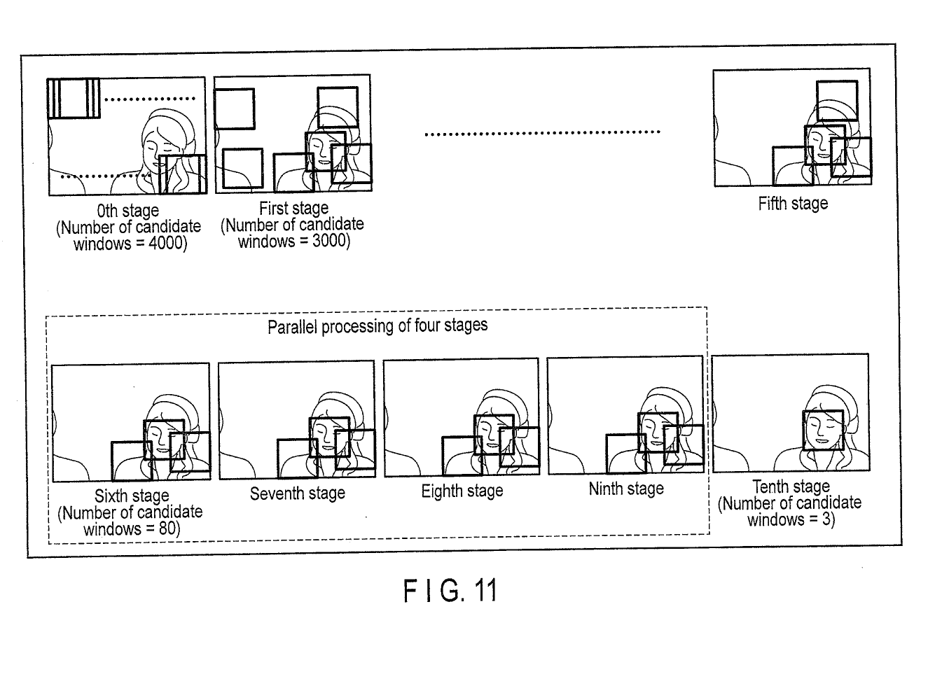

Referring to FIG. 11, a description is given of an example in which two or more stages are parallel-processed in a process (multi-stage process) including a plurality of serially connected stages. It is assumed that a process including a 0th stage to a tenth stage is executed by 400 execution units 21, 22, 23 provided in the GPU 104, and that the sixth stage to the ninth stage are executed in parallel.

In the 0th stage, 4000 threads for screening 4000 candidate windows set by the candidate window setting module 32 are allocated to 400 execution units 21, 22, 23 by the scheduler 20. In the first stage, 3000 threads for screening 3000 candidate windows, which have passed the 0th stage, are allocated to the 400 execution units 21, 22, 23 by the scheduler 20. In the 0th stage and first stage, since the number of threads is greater than the number of execution units 21, 22, 23, the execution units 21, 22, 23 are used without transitioning into an idle state, and independent processes for the candidate windows are executed in parallel. Similarly, in each of the second stage to the fifth stage, threads for screening candidate windows, which have passed the preceding stage, are allocated to the 400 execution units 21, 22, 23.

After 80 candidate windows have passed the fifth stage, four stages, namely the sixth stage to the ninth stage, are executed in parallel. To be more specific, in the sixth stage to ninth stage which are parallel-processed, 320 (=80×4) threads for screening the 80 candidate windows, which have passed the fifth stage, in these four stages are allocated to the 400 execution units 21, 22, 23. Thereby, the number of execution units 21, 22, 23, which transition into an idle state, can be reduced, compared to the case in which only the sixth stage is processed. Therefore, the execution units 21, 22, 23 can be effectively used.

In the seventh stage to ninth stage, candidate windows, which would have been rejected if the parallel processing was not executed, are also processed. In other words, in the seventh stage to ninth stage, a useless process occurs, which would not occur when the stages are serially processed. For example, when 50 candidate windows pass the sixth stage, the 50 candidate windows are processed in the seventh stage if the parallel processing is not executed. However, when the parallel processing is executed, the 80 candidate windows, which have passed the fifth stage, are processed in the seventh stage. Consequently, when the parallel processing is executed, a useless process occurs for the 30 candidate windows.

However, by parallel-processing the four stages, i.e. the sixth stage to ninth stage, the number of threads, which can be operated at the same time, increases from 80 to 320, and thus the parallel processing efficiency of the 400 execution units 21, 22, 23 in the GPU 104 can be enhanced. Accordingly, even if a useless process occurs, execution units 21, 22, 23, which would transition into an idle state if the process of only the sixth stage was executed, can be operated without a halt and can be effectively used. Moreover, since the processing result corresponding to the seventh stage to ninth stage can be obtained at an earlier timing than in the case in which the sixth stage to ninth stage are serially processed, the time needed for the whole process can be shortened.

In the tenth stage, a process for three candidate windows, which have passed the sixth to ninth stages, is executed.

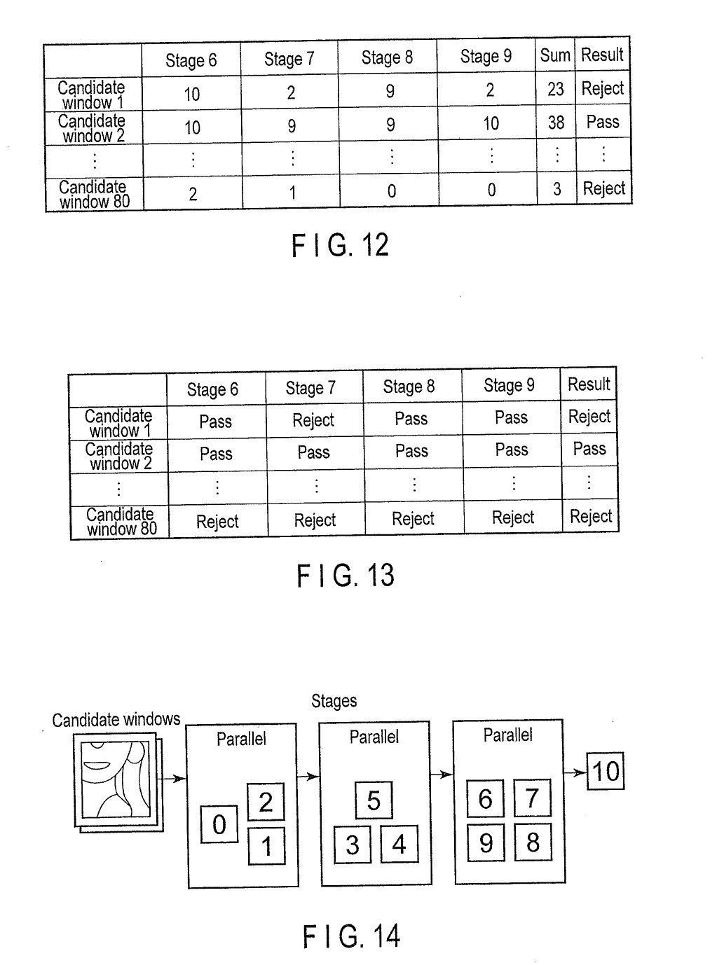

In the above-described parallel processing in which the sixth stage to ninth stage are put together, the pass or rejection of each candidate window is determined by methods as illustrated in FIGS. 12 and 13.

In the example illustrated in FIG. 12, with respect to each of candidate windows, scores in the stages, which have been calculated by the parallel processing, are summed. If the sum is equal to or greater than a threshold, it is determined that the candidate window is to pass the sixth stage to ninth stage. If the sum is less than the threshold, the rejection of this candidate window is determined. For example, when the threshold is set at 30, the rejection of candidate window 1 and candidate window 80 is determined and the pass of candidate window 2 is determined, as illustrated in FIG. 12.

On the other hand, in the example illustrated in FIG. 13, based on scores calculated by the parallel processing, the pass or rejection of each candidate window in each stage is determined. For example, when the score of a certain candidate window in a certain stage is equal to or greater than a threshold, this candidate window is determined to pass this stage. When the score is less than the threshold, it is determined that the candidate window is to be rejected in this stage. A candidate window (candidate window 2), the “Pass” of which has been determined in all parallel-processed stages (in this example, the sixth stage to ninth stage), passes these stages. Candidate windows (candidate window 1 and candidate window 80), the rejection of which has been determined in at least one of the parallel-processed stages, is rejected.

In the meantime, as illustrated in FIG. 14, a parallel processing in which a plurality of stages are put together, may be executed a plurality of number of times. In the example illustrated in FIG. 14, the 0th stage to second stage are processed in parallel, the third stage to fifth stage are processed in parallel, and the sixth stage to ninth stage are processed in parallel. The stage determination module 33 determines two or more stages, which are to be processed in parallel, for example, such that a parallel-processing degree may become constant. The parallel-processing degree is calculated by multiplying the number of candidate windows which passed the preceding stage (i.e. the number of residual candidate windows) by the number of target stages of the parallel processing.

Incidentally, the stage determination module 33 may dynamically vary the target stages of the parallel processing in accordance with information indicative of resources (e.g. the number of execution units 21, 22, 23) which are available when the image processing program 202 is executed.

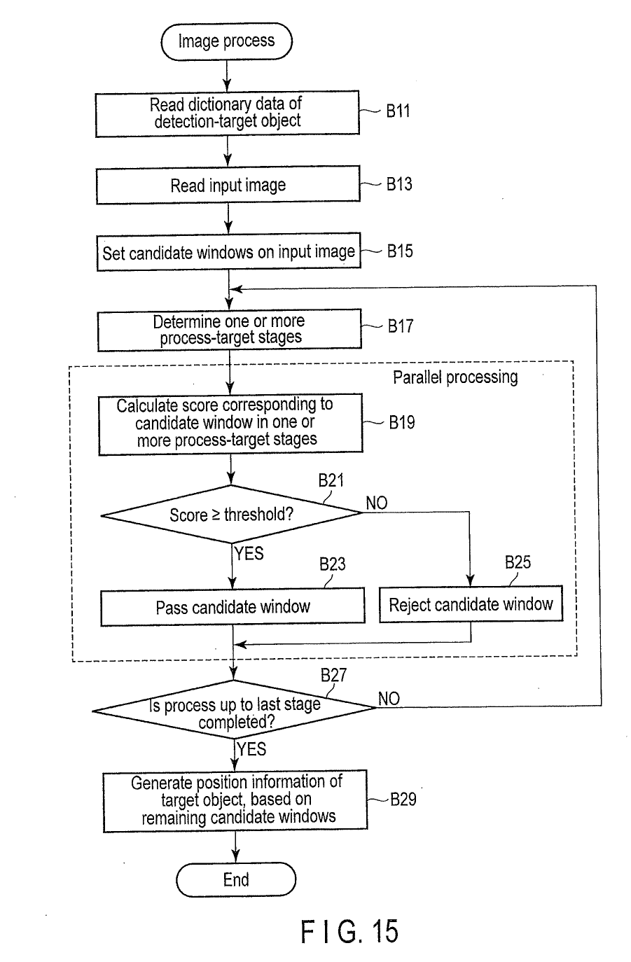

Referring now to a flowchart of FIG. 15, an example of the procedure of the image process is described. In the description below, it is assumed that this image process is a process in which a plurality of stages are provided for detecting an area including a target object from an input image.

To start with, the dictionary reader 31 reads dictionary data indicative of a detection-target object from the storage medium (block B11). This dictionary data includes features for detecting the detection-target object. In addition, the candidate window setting module 32 reads input image data (block B13), and sets a plurality of candidate windows on an input image corresponding to the read input image data (block B15).

Subsequently, the stage determination module 33 determines one or more process-target stages (block B17). The one or more process-target stages may be determined based on a prescribed process order and combination of stages, or may be dynamically determined based on the number of candidate windows or the number of execution units (processor cores) provided in the GPU 104.

Then, a process corresponding to the determined one or more process-target stages is executed. Specifically, a process of the determined one process-target stage, or a process in which the determined two or more process-target stages are parallel-processed, is executed.

To be more specific, the score calculators 35 calculate in parallel the scores of respective candidate windows in each of the determined one or more process-target stages (block B19). Specifically, a plurality of threads for calculating a plurality of scores corresponding to a plurality of candidate windows are allocated to a plurality of execution units provided in the GPU 104, and thereby plural scores are calculated in parallel. The score is high for a candidate window having a feature amount which is close to the appearance of the target object, and is low for a candidate window having a feature amount which is far from the appearance of the target object.

Based on the calculated scores, the pass window determination modules 36 determine in parallel the pass or rejection of the respective candidate windows. Specifically, with respect to the plural candidate widows, each of the pass window determination modules 36 operates in parallel the thread of determining whether the score of a candidate window is a threshold or more (block B21), passing the candidate window (block B23) if the score is the threshold or more (YES in block B21), and rejecting the candidate window (block B25) if the score is less than the threshold (NO in block B21).

Subsequently, the stage determination module 33 determines whether the process up to the last stage has been completed (block B27). When the process up to the last stage has been completed (YES in block B27), the object position information generator 37 generates position information indicative of a position (area) including the target object on the input image, based on residual candidate windows (i.e. candidate windows which have passed all stages) (block B29). On the other hand, when the process up to the last stage has not been completed (NO in block B27), the process returns to block B17, thereby executing a process corresponding to one or more subsequent stages.

In the meantime, the input image in the above description may be one video frame of sequential video frames which constitute video (moving picture). In this case, it is assumed that between an immediately preceding video frame and a present video frame, the number of target objects and the arrangement of the target objects within images are similar. Thus, the stage determination module 33 may determine two or more process-target stages which are to be parallel-processed, based on the number of candidate windows (the number of residual candidate windows) in each stage at a time when the immediately preceding video frame was processed.

However, when a scene change has occurred between an immediately preceding video frame and a present video frame, it is assumed that between the immediately preceding video frame and the present video frame, the number of target objects and the arrangement of the target objects within images are not similar. Thus, based on the correlation of pixel values between the immediately preceding video frame and the present video frame, or based on an interruption of sound between the frames, it is determined whether a scene change has occurred between the immediately preceding video frame and the present video frame. Then, it is determined whether the information relating to the immediately preceding video frame is to be used for determining two or more process-target stages which are to be parallel-processed. Specifically, when a scene change has occurred between the immediately preceding video frame and the present video frame (for example, when the correlation of pixel values between the frames is low), two or more process-target stages, which are to be parallel-processed, are determined without using the information relating to the immediately preceding video frame. When there is no scene change between the immediately preceding video frame and the present video frame (for example, when the correlation of pixel values between the frames is high), two or more process-target stages, which are to be parallel-processed, are determined by using the information relating to the immediately preceding video frame.

As has been described above, according to the present embodiment, when the plural execution units execute the process including serially connected plural stages, the time of this process can be shortened. In the embodiment, two or more stages of a plurality of stages are put together and executed simultaneously, and the number of threads, which can be operated at the same time, is increased. Thereby, the execution units 21, 22, 23 provided in the GPU 104 can be without a halt and can be effectively used. Compared to the case in which the two or stages are serially processed, the time that is needed for the whole process can be decreased.

All the procedures of the image process according to the present embodiment may be executed by software. Thus, the same advantageous effects as with the present embodiment can easily be obtained simply by installing a program, which executes the procedures of the image process, into a computer including a plurality of execution units through a computer-readable storage medium, and by executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
execution units;
a candidate window setting module configured to set candidate windows on an input image;
a stage determination module configured to determine one process-target stage or two or more process-target stages from a plurality of stages which are serially connected, each of the plurality of stages being configured to reject a candidate window of the candidate windows, wherein the rejected candidate window does not comprise a target object;
a score calculator configured to calculate in parallel, scores in each of the two or more process-target stages by the execution units when the two or more process-target stages have been determined, the scores corresponding to the candidate windows; and
a pass window determination module configured to determine in parallel, pass or rejection of each of the candidate windows in the two or more process-target stages by the execution units, based on two or more scores in the two or more process-target stages, the two or more scores corresponding to a candidate window of the candidate windows.

2. The information processing apparatus of claim 1, wherein the score calculator is configured to calculate in parallel, scores in the one process-target stage by the execution units when the one process-target stage has been determined, the scores corresponding to the candidate windows, and
the pass window determination module is configured to determine in parallel, pass or rejection of each of the candidate windows in the one process-target stage by the execution units, based on one score in the one process-target stage, the one score corresponding to a candidate window of the candidate windows.

3. The information processing apparatus of claim 2, wherein the stage determination module is configured to determine new one process-target stage or new two or more process-target stages after the pass or rejection of each of the candidate windows in the one process-target stage or the two or more process-target stages has been determined, the new one process-target stage or the new two or more process-target stages following the one process-target stage or the two or more process-target stages,
the score calculator is configured to calculate in parallel, first scores in the new one process-target stage by the execution units when the new one process-target stage has been determined, the first scores corresponding to passed windows which has been determined by the pass window determination module, and configured to calculate in parallel, second scores in each of the new two or more process-target stages by the execution units when the new two or more process-target stages have been determined, the second scores corresponding to the passed windows, and
the pass window determination module is configured to determine in parallel, pass or rejection of each of the passed windows in the new one process-target stage based on one score in the new one process-target stage by the execution units when the new one process-target stage has been determined, the one score corresponding to a window of the passed windows, and to determine in parallel, pass or rejection of each of the passed windows in the new two or more process-target stages based on two or more scores in the new two or more process-target stages by the execution units when the new two or more process-target stages have been determined, the two or more scores corresponding to a window of the passed windows.

4. The information processing apparatus of claim 1, wherein the pass window determination module is configured to determine that a first candidate window of the candidate windows is to pass the two or more process-target stages if a sum of the two or more scores corresponding to the first candidate window is equal to or greater than a threshold, and to determine that the first candidate window is to be rejected if the sum is less than the threshold.

5. The information processing apparatus of claim 1, wherein the score calculator is configured to calculate the two or more scores corresponding to a first candidate window of the candidate windows, by using pixel values of pixels in the first candidate window and dictionary data indicative of features of the target object for each of the plurality of stages.

6. The information processing apparatus of claim 1, further comprising a position information output module configured to output information based on a candidate window which has passed a last stage of the plurality of stages, the position information indicative of an area on the input image, wherein the area comprises the target object.

7. The information processing apparatus of claim 1, wherein the stage determination module is configured to determine the one process-target stage or the two or more process-target stages based on a number of candidate windows which have passed a preceding stage and a number of the execution units.

8. A parallel processing method of executing in parallel an image process by using execution units, the method comprising:
setting candidate windows on an input image;
determining one process-target stage or two or more process-target stages from a plurality of stages which are serially connected, each of the plurality of stages being configured to reject a candidate window of the candidate windows, wherein the rejected candidate window does not comprise a target object;
calculating in parallel, scores in each of the two or more process-target stages by the execution units when the two or more process-target stages have been determined, the scores corresponding to the candidate windows; and
determining in parallel, pass or rejection of each of the candidate windows in the two or more process-target stages by the execution units, based on two or more scores in the two or more process-target stages,
the two or more scores corresponding to a candidate window of the candidate windows.

9. A computer-readable, non-transitory storage medium having stored thereon a program which causes a computer comprising execution units to execute an image process in parallel, the program controlling the computer to execute functions of:
setting candidate windows on an input image;
determining one process-target stage or two or more process-target stages from a plurality of stages which are serially connected, each of the plurality of stages being configured to reject a candidate window of the candidate windows, wherein the rejected candidate window does not comprise a target object;
calculating in parallel, scores in each of the two or more process-target stages by the execution units when the two or more process-target stages have been determined, the scores corresponding to the candidate windows; and
determining in parallel, pass or rejection of each of the candidate windows in the two or more process-target stages by the execution units, based on two or more scores in the two or more process-target stages, the two or more scores corresponding to a candidate window of the candidate windows.
